(19) United States
(12) Patent Application Publication
(10) Pub. No.: US 2009/0156186 A1
(43) Pub. Date: Jun. 18, 2009

(54) METHOD AND SYSTEM FOR MANAGING CONTACTS IN A MOBILE COMMUNICATIONS DEVICE

(76) Inventor: Ruthie D. Lyle, Durham, NC (US)

Correspondence Address: DILLON & YUDELL LLP, 8911 N. CAPITAL OF TEXAS HWY., SUITE 2110, AUSTIN, TX, 78759, US

(21) Appl. No.: 11/954,818

(22) Filed: Dec. 12, 2007

(51) Int. Cl. H04M 3/42

(52) U.S. Cl. 455/415

(57) ABSTRACT

An improved method, device and computer-readable medium for managing contacts in a mobile communications device are presented. A contact manager receives a telephone call in a mobile communications device and identifies a telephone number associated with the telephone call. If the user attempts to add the number to a contact list, the contact manager consults a contact list policy which is used to determine whether the number is a temporary number. If the telephone number is a temporary number, the telephone number is automatically marked as temporary and automatically assigned a triggering event. The telephone number is automatically removed from the contact list upon an occurrence of the triggering event.

### BACKGROUND OF THE INVENTION

The present invention relates in general to the field of data processing systems, and in particular to data processing systems that can be used as mobile communication devices.

Today's mobile phones allow users to add phone numbers associated with incoming calls to the contact list or address book stored in the device's memory. While this ability is convenient in that it allows the user to quickly store and reference a phone number, it is also cumbersome because the user often permanently stores a telephone number that the user will only need temporarily. Over time, as contacts are added, the user's contact list will become excessively large. Consequently, the user has more content, some of which is deemed irrelevant, to search through when looking for a particular telephone number. The typical solution to this problem is for the user to manually review the contact list periodically and remove telephone numbers that are no longer needed.

### BRIEF SUMMARY OF THE INVENTION

The present invention provides a method, device and computer-readable medium for improved management of contacts in a mobile communications device. In one embodiment, the method includes receiving a telephone call in a mobile communications device; identifying a telephone number associated with that telephone call; automatically searching a contact list of the mobile communications device; determining that the telephone number is not included in the contact list; detecting an attempt by a user of the mobile communications device to add the telephone number to the contact list; and determining whether a contact list policy of the mobile communications device indicates the telephone number is a temporary telephone number. In response to determining that the contact list policy does not indicate the telephone number is a temporary telephone number, the method includes storing the telephone number in the contact list. In response to determining that the contact list policy indicates the telephone number is a temporary telephone number, the method includes: storing the telephone number in the contact list; automatically marking the telephone number as temporary; automatically assigning a triggering event to the telephone number, wherein the telephone number is automatically removed from the contact list upon an occurrence of the triggering event; and displaying an indication to the user that the telephone number has been stored as a temporary telephone number.

The above, as well as additional purposes, features, and advantages of the present invention will become apparent in the following detailed written description.

### BRIEF DESCRIPTION OF THE SEVERAL VIEWS OF THE DRAWINGS

The novel features believed characteristic of the invention are set forth in the appended claims. The invention itself, however, as well as a best mode of use, further purposes and advantages thereof, will best be understood by reference to the following detailed description of an illustrative embodiment when read in conjunction with the accompanying drawings, where:

FIG. 1 is a block diagram of an exemplary mobile communications device in which the present invention may be implemented;

FIG. 2 is a flowchart that depicts an exemplary method for improved management of contacts in a mobile communications device, in accordance with one or more embodiments of the present invention; and

FIG. 3 is a continuation of the flowchart in FIG. 2.

### DETAILED DESCRIPTION OF THE INVENTION

An illustrative embodiment of the present invention is directed to an improved method, system and computer-readable medium for managing contacts in mobile communications devices. The present invention can take the form of an entirely hardware embodiment, an entirely software embodiment or an embodiment containing both hardware and software elements. In an illustrative embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus or device.

The medium can be an electronic, magnetic, optical, electromagnetic, infrared or semiconductor system, apparatus or device or a propagation medium. Examples of a computer-readable medium include a semiconductor or solid state memory (e.g., flash drive memory), magnetic tape, a removable computer diskette, a random access memory (RAM), a read-only memory (ROM), a rigid magnetic disk (e.g., a hard drive) and an optical disk. Current examples of optical disks include compact disk-read only memory (CD-ROM), compact disk-read/write (CD-R/W) and Digital Versatile Disk (DVD).

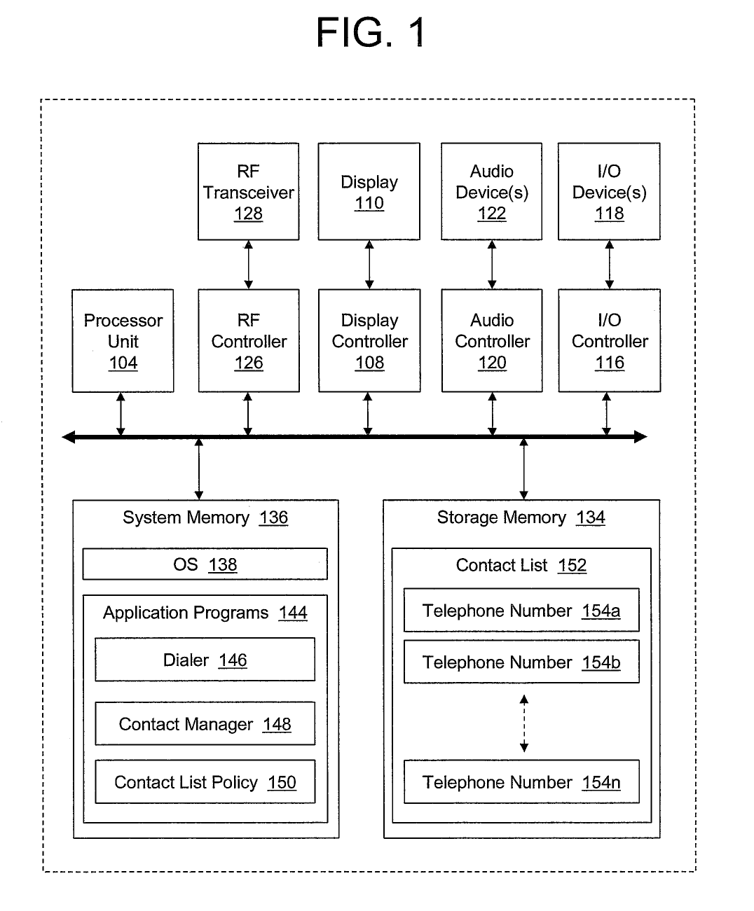

Referring now to the drawings, wherein like numbers denote like parts throughout the several views, FIG. 1 shows a block diagram of mobile communications device 102 suitable for storing and/or executing program code in accordance with one or more embodiments of the present invention. The hardware elements depicted in mobile communications device 102 are not intended to be exhaustive, but rather are representative of one embodiment of the present invention. Mobile communications device 102 includes processor unit 104 that is coupled to system bus 106. Display controller 108, which drives/supports display 110, is also coupled to system bus 106. I/O controller 116 is coupled to system bus 106. Input/Output (“I/O”) controller 116 affords communication with one or more I/O devices, such as I/O device 118. Examples of I/O device 118 include, but are not limited to, a keypad, a touch screen and a synchronization interface that enables communication with a personal computer (PC). Audio controller 120 is coupled to system bus 106. Audio controller 120 drives/supports audio device 122 (e.g., a microphone, a speaker, a handsfree/headset device, etc). Radio Frequency (“RF”) controller 126 is coupled to system bus 106. RF controller 126 drives/supports RF transceiver 128, which sends and receives radio signals. In modem mobile phone systems (e.g., GSM, CDMA, UMTS), RF transceiver 128 sends and receives radio frequency signals to and from a base station in a manner well known in the art.

Storage memory 134 is coupled to system bus 106. Storage memory 134 may include non-volatile solid state memory, a subscriber identity module (SIM) card, and removable flash memory (e.g., microSD card). Storage memory 134 includes contact list 152. Contact list 152 includes telephone numbers 154a-n. In an illustrative embodiment, storage memory 134 populates system memory 136, which is also coupled to system bus 106. Data that populates system memory 136 includes an operating system (OS) 138 of mobile communications device 102 and application programs 144.

OS 138 provides user access to resources such as application programs 144. OS 138 also includes lower levels of functionality, including providing essential services such as memory management, process and task management, storage management, and input device management. OS 138 may be a proprietary operating system specifically designed for mobile communications device 102. Or OS 138 may be an operating system used in a variety of mobile communications devices, such as Symbian OS™, Embedded Linux, Windows Mobile® or Palm OS®.

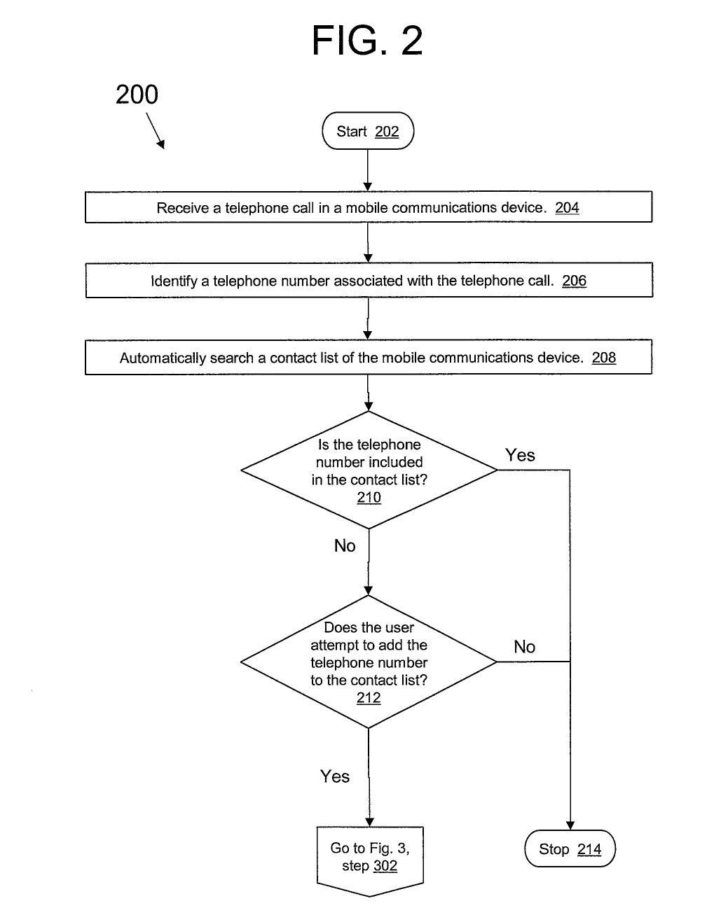

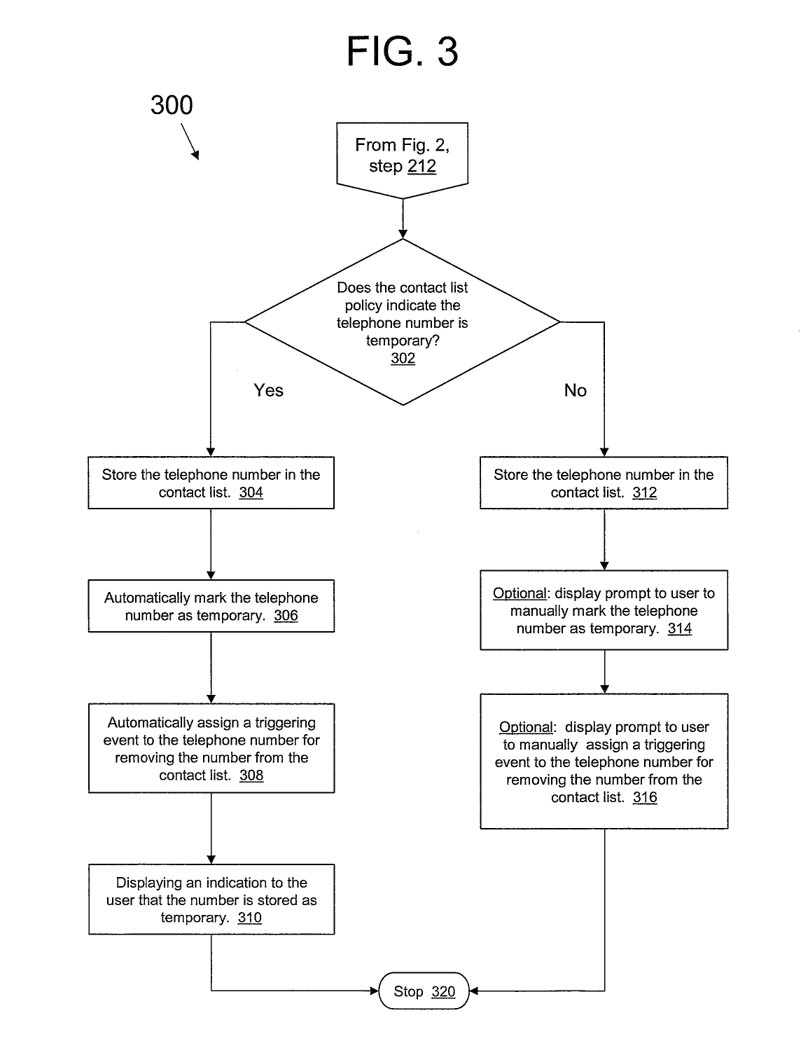

Application programs 144 in the system memory of mobile communications device 102 include dialer 146. Dialer 146 is an application program provides the user a facility for placing and answering telephone calls. Application programs 144 also include contact manager 148. Contact manager is an application program that enables a user view, add, delete or edit contact list 152 and telephone numbers 154a-n stored therein. Contact manager 148 also comprises computer-executable code, at least a portion of which implements the method described herein. Contact manager 148 includes contact list policy 150, which is described in further detail in reference to FIG. 2 and FIG. 3. Contact list policy 150 may reside in system memory 136, as shown, and/or may be stored in non-volatile bulk storage such as storage memory 134.

The hardware elements depicted in mobile communications device 102 are not intended to be exhaustive, but rather are representative to highlight exemplary components of a device suitable for implementing one embodiment of the present invention. For instance, while one system bus 106 is shown, one skilled in the art will recognize that more than one bus may be used, interconnected by a bus bridge, for providing higher speed bus for devices such as processor unit 104 and a lower speed bus for devices such as I/O/ device 118 in a manner well known in the art. These and other variations are intended to be within the spirit and scope of the present invention.

With reference now to FIG. 2, flowchart 200 is shown depicting an improved method for managing contacts in mobile communications device 102, in accordance with one or more embodiments of the present invention. The process begins at initiator 202. Mobile communications device 204 receives a telephone call (step 204). Contact manager 148 identifies the telephone number associated with the telephone call (step 206). For example, contact manager 148 identifies the telephone number from caller identification information provided with the telephone call by a mobile telephone service provider. Contact manager 148 automatically searches contact list 152 (step 208) and determines whether the telephone number of the received telephone call is included in contact list 152. If the telephone number is already included in contact list 152, the process ends at terminator 214. If the telephone number is not included in contact list 152, contact manager 148 determines whether the user of mobile communications device 102 attempts to add the telephone number to contact list 152. If the user does not attempt to add the telephone number to contact list 152, the process ends at terminator 214. If the user does attempt to add the telephone number to contact list 152, the process proceeds to step 302 of FIG. 3.

With reference now to FIG. 3, flowchart 300, which is an extension of flowchart 200 of FIG. 2, is shown. If the user does attempt to add the telephone number to contact list 152 at step 212, contact manager 148 determines whether contact list policy 150 indicates that the telephone number is a temporary number (step 302). Contact list policy 150 contains predefined criteria for determining whether a telephone number should be stored as a temporary telephone number. For example, contact list policy 150 may include criteria to automatically identify a telephone number as temporary according to an attribute associated with the telephone number such as a name, physical location of the caller, the caller's network, the area code of the caller, etc. Contact list policy 150 may include a criterion to automatically identify a telephone number as temporary if the telephone number was recently dialed by user, and a return call is received. Contact list policy 150 may include criteria to automatically identify a telephone number as temporary during a particular time period or on a particular day. In one embodiment of the present invention, contact list policy 150 is user-customizable.

Contact list policy 150 also includes criteria for automatically assigning a triggering event to telephone number that has been marked temporary. Upon an occurrence of the triggering event, the telephone number that has been marked temporary is automatically removed from contact list 152. For example, contact list policy 150 may define a triggering event to remove a telephone number marked as temporary after a specified time duration (e.g., remove the number after 24 hours). Contact list policy 150 may define a triggering event to remove a telephone number marked as temporary based upon an action of the user (e.g., remove the number the next time the user called the telephone number marked as temporary). Contact list policy 150 may utilize metadata associated with the telephone number to automatically mark the telephone number as temporary and assign a triggering event to automatically remove the number upon an occurrence of the triggering event.

At step 302, contact manager 148 determines whether contact list policy 150 indicates that the telephone number is a temporary number. If contact list policy 150 indicates that the telephone number is a temporary number, then contact manager 148 stores the telephone number in contact list 152 (step 304). Contact manager 148 automatically marks the telephone number as temporary (step 306). Contact manager 148 automatically assigns a triggering event to the telephone number for automatically removing the telephone number upon an occurrence of the triggering event (step 308). Contact manager 148 displays an indication to the user that the telephone number has been stored as a temporary number (step 310). The indication may also include information about the triggering event that was assigned to the telephone number. The process ends at terminator 320.

If, at step 302, contact list policy 150 indicates that the telephone number is not a temporary number, then contact manager 148 stores the telephone number in contact list 152 without automatically marking the telephone number as temporary (step 312). In one embodiment of the present invention, the process proceeds to terminator 320 and ends. In an alternative embodiment of the present invention, the process proceeds to step 314, where contact manager 148 displays a prompt to the user (e.g., via display 110) to manually (e.g., via I/O device 118) mark the telephone number as temporary. The prompt of step 314 enables the user to manually mark telephone numbers as temporary even though contact list policy 150 does not indicate that the telephone number is a temporary number. At step 316, contact manager 148 displays a prompt to the user to manually assign a triggering event to the telephone number for automatically removing the number from the contact list upon an occurrence of the triggering event. The prompt of step 316 enables the user to manually assign a triggering event to the telephone number for automatically removing the number even though contact list policy 150 does not indicate that the telephone number is a temporary number. In one embodiment, the prompt of step 316 may display a list of potential triggering events that user may select for the telephone number. The process ends at terminator 320.

In one embodiment of the present invention, contact manager 148 displays telephone numbers marked as temporary to the user in contact list 152, merged alphabetically with numbers that are not marked as temporary. In an alternative embodiment of the present invention, contact manager 148 displays telephone numbers to the user marked as temporary in contact list 152 separately from numbers that are not marked as temporary. The temporary telephone numbers may be displayed to the user alphabetically, according to expiration, etc.

While the present invention has been particularly shown and described with reference to an illustrative embodiment, it will be understood by those skilled in the art that various changes in form and detail may be made therein without departing from the spirit and scope of the invention. The flowchart and diagrams in the Figures illustrate the architecture, functionality, and operation of possible implementations of systems, methods and computer program products according to various embodiments of the present invention. In this regard, each block in the flowchart or diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to illustrative embodiments thereof, it will be apparent that modifications and variations are possible without departing from the scope of the invention defined in the appended claims.

What is claimed is:

1. A method in a mobile communications device comprising:
receiving a telephone call in a mobile communications device;
identifying a telephone number associated with the telephone call;
automatically searching a contact list of the mobile communications device;
determining that the telephone number is not included in the contact list;
detecting an attempt by a user of the mobile communications device to add the telephone number to the contact list;
determining whether a contact list policy of the mobile communications device indicates the telephone number is a temporary telephone number;
in response to determining that the contact list policy does not indicate the telephone number is a temporary telephone number, storing the telephone number in the contact list;
in response to determining that the contact list policy indicates the telephone number is a temporary telephone number:
storing the telephone number in the contact list;
automatically marking the telephone number as temporary;
automatically assigning a triggering event to the telephone number, wherein the telephone number is automatically removed from the contact list upon an occurrence of the triggering event; and
displaying an indication to the user that the telephone number is stored as a temporary telephone number.

2. The method of claim 1, wherein the response to determining that the contact list policy does not indicate the telephone number is a temporary telephone number further comprises:
displaying a prompt to the user to manually mark the telephone number as temporary; and
displaying a prompt to the user to manually assign a triggering event to the telephone number, wherein the telephone number is automatically removed upon an occurrence of the triggering event.

3. The method of claim 1, wherein said contact list policy is defined by the user.

4. The method of claim 1, wherein the telephone number is automatically marked as temporary in response to the telephone number of the telephone call being a number that was recently dialed by the user.

5. The method of claim 1, wherein the telephone number is automatically marked as temporary in response to the telephone call being received during a predefined time period.

6. The method of claim 1, wherein the telephone number is automatically marked as temporary in response to an attribute associated with the telephone number.

7. The method of claim 1, wherein the triggering event is set to occur after a predefined period of time.

8. A mobile communications device comprising:
means for receiving a telephone call in a mobile communications device;
means for identifying a telephone number associated with the telephone call;
means for automatically searching a contact list of the mobile communications device;
means for determining that the telephone number is not included in the contact list;
means for detecting an attempt by a user of the mobile communications device to add the telephone number to the contact list;
means for determining whether a contact list policy of the mobile communications device indicates the telephone number is a temporary telephone number;
means, responsive to determining that the contact list policy does not indicate the telephone number is a temporary telephone number, for storing the telephone number in the contact list;
means, responsive to determining that the contact list policy indicates the telephone number is a temporary telephone number, comprising:
means for storing the telephone number in the contact list;
means for automatically marking the telephone number as temporary;
means for automatically assigning a triggering event to the telephone number, wherein the telephone number is automatically removed from the contact list upon an occurrence of the triggering event; and
means for displaying an indication to the user that the telephone number is stored as a temporary telephone number.

9. The device of claim 8, wherein the means responsive to determining that the contact list policy does not indicate the telephone number is a temporary telephone number further comprises:
means for displaying a prompt to the user to manually mark the telephone number as temporary; and
means for displaying a prompt to the user to manually assign a triggering event to the telephone number, wherein the telephone number is automatically removed upon an occurrence of the triggering event.

10. The device of claim 8, wherein said contact list policy is defined by the user.

11. The device of claim 8, wherein the means for automatically marking the telephone number as temporary is responsive to the telephone number of the telephone call being a number that was recently dialed by the user.

12. The device of claim 8, wherein the means for automatically marking the telephone number as temporary is responsive to the telephone call being received during a predefined time period.

13. The device of claim 8, wherein the means for automatically marking the telephone number as temporary is responsive to an attribute associated with the telephone number.

14. The device of claim 8, wherein the triggering event is set to occur after a predefined period of time.

15. A computer program product comprising:
a computer-readable medium encoded with a computer program that, when executed, causes control circuitry within a mobile communications device to perform the steps of:
receiving a telephone call in a mobile communications device;
identifying a telephone number associated with the telephone call;
automatically searching a contact list of the mobile communications device;
determining that the telephone number is not included in the contact list;
detecting an attempt by a user of the mobile communications device to add the telephone number to the contact list;
determining whether a contact list policy of the mobile communications device indicates the telephone number is a temporary telephone number;
in response to determining that the contact list policy does not indicate the telephone number is a temporary telephone number, storing the telephone number in the contact list;
in response to determining that the contact list policy indicates the telephone number is a temporary telephone number:
storing the telephone number in the contact list;
automatically marking the telephone number as temporary;
automatically assigning a triggering event to the telephone number, wherein the telephone number is automatically removed from the contact list upon an occurrence of the triggering event; and
displaying an indication to the user that the telephone number is stored as a temporary telephone number.

16. The computer program product of claim 15, wherein the response to determining that the contact list policy does not indicate the telephone number is a temporary telephone number further comprises:
displaying a prompt to the user to manually mark the telephone number as temporary; and
displaying a prompt to the user to manually assign a triggering event to the telephone number, wherein the telephone number is automatically removed upon an occurrence of the triggering event.

17. The computer program product of claim 15, wherein said contact list policy is defined by the user.

18. The computer program product of claim 15, wherein the telephone number is automatically marked as temporary in response to the telephone number of the telephone call being a number that was recently dialed by the user.

19. The computer program product of claim 15, wherein the telephone number is automatically marked as temporary in response to the telephone call being received during a predefined time period.

20. The computer program product of claim 15, wherein the triggering event is set to occur after a predefined period of time.
